(19) United States
(12) Patent Application Publication
(10) Pub. No.: US 2025/0290387 A1
(43) Pub. Date: Sep. 18, 2025

(54) DIFFERENTIAL PRESSURE ACTUATED FLOW VALVE

(71) Applicant: MS Directional, LLC, Conroe, TX (US)

(72) Inventors: Libo Yang, Katy, TX (US); Victor Matthew Bolze, Houston, TX (US); Shyam B. Mehta, Missouri City, TX (US); Peter Nicholas Wells, Houston, TX (US); Richard Mark Wilde, Hockley, TX (US)

(73) Assignee: MS Directional, LLC, Conroe, TX (US)

(21) Appl. No.: 19/077,461

(22) Filed: Mar. 12, 2025

Related U.S. Application Data
(60) Provisional application No. 63/565,437, filed on Mar. 14, 2024.
(60) Provisional application No. 63/681,267, filed on Aug. 9, 2024.

(51) Int. Cl. E21B 34/08; F16K 15/18

(52) U.S. Cl. CPC E21B 34/08; E21B 2200/04; F16K 15/1823

(57) ABSTRACT

The disclosure provides an improved fluid operated pulser. The pulser utilizes a pilot valve to create differential pressure to directly actuate a main valve to block or unblock a fluid flow. The invention provides a main valve that is simpler, more reliable, and wear resistant. The invention uses a differential pressure inside the volume under a pilot valve to directly actuate a main valve to block or unblock the fluid flow through the orifice, and thus creates a positive pressure pulse inside the collar. The main valve has only one moving part, the main valve element, and sometimes a spring. The main valve element can be spherical or cylindrical and rotate in a volume adjacent the pilot valve. The variable exposure of surface area results in reduced erosion on the main valve element to extend the main valve life, and reduced need for stopping expensive operations to replace the pulser.

### CROSS REFERENCE TO RELATED APPLICATIONS

This application claims the benefit of U.S. Provisional Application Ser. No. 63/681,267, entitled “Differential Pressure Actuated Flow Valve”, filed Aug. 9, 2024, and U.S. Provisional Application Ser. No. 63/565,437, entitled “Differential Pressure Actuated Flow Valve”, filed Mar. 14, 2024, and are incorporated herein by reference.

### STATEMENT REGARDING FEDERALLY SPONSORED RESEARCH OR DEVELOPMENT

Not applicable

### REFERENCE TO APPENDIX

Not applicable

### BACKGROUND OF THE INVENTION

### Field of the Invention

The disclosure generally relates to remote communications in a fluid using coded pulses through the fluid. More specifically, the disclosure relates to communications between subsurface equipment and surface equipment using fluidic pulses, such as during drilling hydrocarbon wells.

### Description of the Related Art

FIG. 1 is a schematic example of a typical overall system using telemetry mud pulses to communicate data between a downhole tool in a well bore and a surface equipment. An oil rig 34 generally is used to drill a hydrocarbon well 35 to establish a wellbore 36. A drill string 37 of pipe and tooling is progressively inserted into the wellbore as the drill bit progressively deepens the wellbore. A mud pump 38 pumps mud through an inlet conduit 39 to the drill string 37 to travel downward through the drill string and through a downhole telemetry tool 40 with a modulator and a Bottom Hole Assembly (BHA) 41 with a drill bit to help flush cuttings from the drill bit. The mud pressure causes the mud and cuttings to return up an annulus between the larger wellbore and the smaller drill string to the surface and into a return conduit 42. The mud flows over a screen to separate larger particles and returns to the mud pit 43. In oil field operations for Measurement While Drilling (MWD) services, various measurements are acquired downhole and sent from the downhole telemetry tool 40 that aggregates the measurement data and sends the data using various telemetry methodology like mud-pulse, electromagnetic, acoustic, wired drill pipe and others, with mud-pulse being predominant in the industry. A related process is Logging While Drilling (LWD). The MWD and/or LWD can be generally referred to herein as MLWD and the downhole telemetry tool 40 is typically an MLWD tool in an MLWD system that can transmit measurement data via telemetry to an uphole station 102 generally with a processor for extracting the telemetry data. Current MLWD methodology using mud telemetry depends on the mud flowing in the downhole pipes and actively circulating in a drilling column circuit between downhole and surface locations. The telemetry is typically sent in sequences by partially interrupting the flow of mud to create a pressure differential into a specifically timed and sized pulse or series of pulses that are decoded by the receiving side to communicate. A similar operation, not shown, is to deploy a similar valve at the surface to partially siphon off the mud from a standpipe to vary the pressure and create pulses in the mud stream. Modulation of these pulses can send messages to the downhole MLWD tool.

FIG. 2A is a schematic cross-sectional diagram of the operation of a typical positive pulse mud-operated pulser. FIG. 2B is a schematic cross-sectional diagram of an example of a typical mud operated pulser showing a poppet and orifice interface. FIG. 2C is an exemplary graph of positive pulses from a mud-operated pulser. There are two basic methods (negative or positive pressure generation) to send pressure signals to surface. The most widely used MLWD system considers the second method that sends positive pressure signals to surface. A positive pulse is created by increasing the local differential pressure at a point in the tool where part of the flow area of the mud is temporarily blocked to establish a zone of “high-pressure” 208 shown in FIG. 2C that is understood as higher than steady state pressure 209. The differential pressure propagates a pulse to the surface, yet still allows flow across the drill bit. The flow area can be restricted with an axial motion or rotational motion.

An example of restricting the flow with axial motion is a Mud Operated Pulser (MOP) 204. A MOP is one of most widely used MLWD systems in the industry. The function of a MOP is to extend and retract a poppet 205 (a main valve) in the form of a needle valve in an orifice 206 repeatedly to generate pressure pulses with a desired pulse width, amplitude, and pulse spacing.

As shown in FIG. 2A, when the poppet 205 is in open position, retracted downward in its normal state, the flow of the mud is not restricted and hence creates a steady low-pressure. When an electronic controller 207 actuates the needle valve, the needle valve moves upward into the orifice 206, choking the flow of the mud partially, as shown in FIG. 2B and creating a higher pressure above the valve. In a normal MLWD operation, these pressure changes travel upwards within the drill pipe to the surface. Using this mechanism, the MLWD tool creates a series of pulses, as shown in FIG. 2C. By modulating the pulse width or pulse spacing relative to other pulses, a message can be transmitted to the surface as a digital communication and decoded.

FIG. 3A is a schematic cross-sectional view of a typical mud operated pulser with details of portions. FIG. 3B is an enlarged cross-sectional view of a pilot valve of the pulser of FIG. 3A. FIG. 3C is an enlarged cross-section view of a spring and piston of the pulser of FIG. 3A. FIG. 3D is an enlarged cross-sectional view of a poppet and orifice as a main valve of the pulser of FIG. 3A. The MOP 212 has a pilot valve 213 located in an upstream position on the MOP. The pilot valve opens and closes a servo tip 214 against a servo seat 215 to operate the MOP. A piston 217 is spring-loaded with a main spring 216 in compression to bias downhole a hydraulic piston. Notches 220 on the piston allow placement of O-rings to seal the piston against the wall of the housing. It is known that the O-rings wear quickly in the environment and need frequent replacement, costing loss of production time. Movement of the hydraulic piston in turn moves a poppet 222, as a valve, relative to an orifice 223 to create a flow change that produces a back pressure and a coded pulse to communicate uphole.

FIG. 4A is a schematic cross-sectional view of the mud operated pulser of FIG. 3A when the pilot valve is closed, the poppet is in the orifice, and the mud pump is off. FIG. 4B is an enlarged schematic cross-sectional view of the closed pilot valve of the mud operated pulser of FIG. 4A. FIG. 4C is an enlarged schematic cross-sectional view of the poppet partially in the orifice of the mud operated pulser of FIG. 4A with a mud pump off. FIG. 4D is schematic cross-sectional view of the closed pilot valve of the mud operated pulser of FIG. 3A when the pilot valve is closed, the poppet is out the orifice, and the mud pump is on. FIG. 4E is an enlarged schematic cross-sectional view of the poppet out of the orifice of the mud operated pulser of FIG. 4D with the mud pump on. Generally, the MOP includes a pilot valve 213 in an uphole position that controls a poppet 222 (as the main valve) relative to an orifice 223 downhole of the pilot valve. The pilot valve is closed with a cover slidably actuated across an uphole opening of the MOP to allow the pilot valve to seat and close. To open the pilot valve, the cover is slidably actuated away from the uphole opening to allow high-pressure mud flow through the pilot valve for actuation of the pulser.

The pilot valve 213 includes a servo tip 214 that raises and lowers from a servo seat 215 from actuation of the pilot valve, which in turn raises and lowers the poppet 222 relative to the orifice 223 by applying pressure to the spring-biased hydraulic piston coupled to the poppet. Clearance around the poppet while in the orifice still allows flow through the MOP and downhole through the drill bit or other equipment, yet sufficiently restricts flow so that the pressure differential creates a pulse.

Stages of a typical pressure generation are described below.

As shown in FIGS. 4A-4C, in a rest state, the pilot valve 213 is closed and the pump is off, allowing the poppet 222 to be situated in the orifice 223. When the pilot valve is closed and the pump is on, the poppet 222 is raised out of the orifice 223, as shown in FIGS. 4D-4E. In both cases, whether the pump is ON or OFF, and the pilot valve is closed, then the fluid trapped under the pilot valve volume flows via a small restrictive channel to a low-pressure zone below the orifice. The high-pressure fluid between a surrounding wall of the MOP, known as a “collar”, and outside the valve body, pushes up on the bottom of the piston shaft 219 and keeps the poppet 222 out of the orifice 223, thus creating the steady state lower pressure. Concurrently with the piston movement upward, the fluid trapped under the pilot valve volume will leak out through a channel in the middle of the piston to the low-pressure zone in the orifice 223.

FIG. 5A is a schematic cross-sectional view illustrating pressure conditions of portions of the mud operated pulser of FIG. 3A when the pilot valve is closed, and the pump is on. FIG. 5B is an enlarged schematic cross-sectional view of a portion of FIG. 5A. The fluid in the volume under the pilot valve 213 leaks through the small channel to the low-pressure zone downhole below the orifice. Thus, low-pressure is created inside the volume under the pilot valve when the pilot valve is closed. High-pressure between the collar and the valve body exerts an upward force under a piston 217 downhole of the pilot valve. This high-pressure around the MOP flows through side ports into the volume under the piston. The low-pressure under the pilot valve allows the higher pressure below the piston to push the piston into the volume under the pilot valve, and thus raise the poppet 222 upward from the orifice 223 and pre-load the spring. Because the piston is attached to the poppet, the movement upward of the piston pulls the poppet out of the orifice. Because the poppet 222 does not block the mud flowing into the orifice, the pressure inside the collar is lower and represents the steady state as shown in FIG. 2.

FIG. 6A is a schematic cross-sectional view of the typical mud operated pulser of FIG. 3A when the pilot valve initially opens, and the poppet starts to enter the orifice. FIG. 6B is an enlarged cross-sectional view of a pilot valve of the pulser of FIG. 3A when the pilot valve is initially opening. FIG. 6C is an enlarged cross-sectional view of a poppet and orifice as a main valve of the pulser of FIG. 6A, when the pilot valve is initially opening, and the poppet is starting to be situated within the orifice cross-sectional area. FIG. 6D is a schematic cross-sectional view of the mud operated pulser of FIG. 6A when the pilot valve is fully open, and the poppet is in the orifice to generate a pulse. FIG. 6E is an enlarged cross-sectional view of a poppet and orifice as a main valve of the pulser of FIG. 6D, when the pilot valve is fully open, and the poppet is situated in full position within the orifice cross-sectional area. When the pilot valve 213 starts to open in FIGS. 6A-6C, the pressure inside the volume under the pilot valve starts to increase and equalize with the pressure around the MOP. The spring-loaded piston 217 starts to lower and the poppet 222 enters the orifice 223. When the pressure is substantively equalized, the spring 219 can complete the stroke of the piston and push the poppet 222 into position within the volume of the orifice 223, as shown in FIGS. 6D-6E. Because the poppet sufficiently restricts the mud flowing into the orifice, a positive pressure pulse is generated inside the collar. After the pulse, the pilot valve can be closed to reset the MOP for the next pulse.

Despite wide usage, the typical MOP suffers several problems. The design is relatively complex with the piston with seals, signal shaft, and poppet that must work under dirty mud conditions in high-speed repetitive cycles to generate the pulses. In some cases, the pulse rate could be in sub-second range on continuous bases. The MOP is known to be costly to manufacture due to its complexity and operational repair costs are high. As described above, the differential pressure inside the volume under the pilot valve actuates the piston, which connects with the poppet and moves the poppet in and out of an orifice to create a positive pressure pulse inside the collar. The moving parts generally require rebuilding after each use or run, that is every time it comes out of the wellbore. Further, the piston has a seal around its perimeter. Due to the constant movement of the piston and the abrasiveness of the mud flow, the piston suffers from severe erosion and the seal rapidly wears out. Also, axial shocks during operation are directly transferred to the piston assembly, further contributing to wear on the piston and the pilot valve. Reliability is a known issue. Typical failure modes that compromise the MOP functioning include the piston cap eroding and the piston ceramic orifice cracking. Due to these failure modes, many times the drill string of pipe and equipment must be pulled out of the wellbore and replaced with a new pulser assembly to go back into the wellbore to finish the run. Pulling out of the wellbore and going back in just to replace the pulser assembly is a very expensive operation on a drilling rig and reduces the overall drilling efficiency.

Therefore, there remains a need for an improved MOP that is simpler and more reliable.

### BRIEF SUMMARY OF THE INVENTION

The disclosure provides an improved fluid operated pulser, such one using drilling mud as the fluid. The pulser utilizes a pilot valve to create differential pressure to directly actuate a main valve to block or unblock a main fluid flow. The invention provides a main valve that is simpler, more reliable, and wear resistant. The invention uses a differential pressure inside the volume adjacent a pilot valve to directly actuate a main valve to block or unblock the fluid flow through the orifice, and thus creates a positive pressure pulse inside the collar that can be transmitted in the fluid stream. The main valve has only one moving part, the main valve element. In some embodiments, a main spring is also used. The main valve element can be spherical or cylindrical and rotate in a volume adjacent the pilot valve. The variable exposure of surface area results in reduced erosion on the main valve element to extend the main valve life, and a reduced need to pull the drill pipe and equipment out of the wellbore just to replace the pulser assembly.

Because the improved pulser design has fewer moving parts, the invention improves reliability significantly. The improved pulser design is more resistant to erosion, also known as “wash”. The improved pulser design reduces or eliminates the failure modes of the typical pulser, including the piston cap wash and piston ceramic orifice crack and eliminates the annular sliding seals around the piston. Its operational cost is lower because it does not require rebuilding worn or broken components after each run. Due to the simplicity, its unit manufacturing cost is lower. The invention is not just restricted to downhole drilling operations. It is applicable as an innovative valve wherever there is a need to restrict flow on a periodic fashion. Some other contemplated applications are the valve being used to siphon fluid from a surface standpipe back to a tank to create pressure and flow variation going downhole to the MLWD tool to send downlink messages. Also, the invention can be used in applications of marine communications underwater and other applications.

The disclosure provides a fluid-operated pulser comprising: a pilot valve configured to selectively allow fluid to flow through the pilot valve; and a hydraulic main valve fluidicly coupled to the pilot valve, the hydraulic main valve comprising: a main valve tube having a main valve tube volume and fluidicly coupled to the hydraulic pilot valve; a main valve orifice having an opening to allow the fluid to flow through the main valve orifice; a main valve element longitudinally movable in the main valve tube between the pilot valve and the main valve orifice and selectively engageable with the opening of the main valve orifice to selectively allow the fluid to flow through the main valve orifice; and a flow bleed path channel fluidicly coupled between the main valve tube volume and a lower pressure zone.

### BRIEF DESCRIPTION OF THE SEVERAL VIEWS OF THE DRAWINGS

FIG. 1 is a schematic example of a typical overall system using telemetry drilling mud pulses to communicate data between a downhole tool in a well bore and a surface equipment.

FIG. 2A is a schematic cross-sectional diagram of the operation of a typical positive pulse mud-operated pulser.

FIG. 2B is a schematic cross-sectional diagram of an example of a typical mud operated pulser showing a poppet and orifice interface.

FIG. 2C is an exemplary graph of positive pulses from a mud-operator pulser.

FIG. 3A is a schematic cross-sectional view of a typical mud operated pulser with details of portions.

FIG. 3B is an enlarged cross-sectional view of a pilot valve of the pulser of FIG. 3A.

FIG. 3C is an enlarged cross-section view of a spring and piston of the pulser of FIG. 3A.

FIG. 3D is an enlarged cross-sectional view of a poppet and orifice as a main valve of the pulser of FIG. 3A.

FIG. 4A is a schematic cross-sectional view of the mud operated pulser of FIG. 3A when the pilot valve is closed, the poppet is in the orifice, and the mud pump is off.

FIG. 4B is an enlarged schematic cross-sectional view of the closed pilot valve of the mud operated pulser of FIG. 4A.

FIG. 4C is an enlarged schematic cross-sectional view of the poppet partially in the orifice of the mud operated pulser of FIG. 4A with a mud pump off.

FIG. 4D is schematic cross-sectional view of the closed pilot valve of the mud operated pulser of FIG. 3A, when the pilot valve is closed, the poppet is out the orifice, and the mud pump is on.

FIG. 4E is an enlarged schematic cross-sectional view of the poppet out of the orifice of the mud operated pulser of FIG. 4D with the mud pump on.

FIG. 5A is a schematic cross-sectional view illustrating pressure conditions of portions of the mud operated pulser of FIG. 3A when the pilot valve is closed, and the pump is on.

FIG. 5B is an enlarged schematic cross-sectional view of a portion of FIG. 5A.

FIG. 6A is a schematic cross-sectional view of the typical mud operated pulser of FIG. 3A when the pilot valve initially opens, and the poppet starts to enter the orifice.

FIG. 6B is an enlarged cross-sectional view of a pilot valve of the pulser of FIG. 3A when the pilot valve is initially opening.

FIG. 6C is an enlarged cross-sectional view of a poppet and orifice as a main valve of the pulser of FIG. 6A, when the pilot valve is initially opening, and the poppet is starting to be situated within the orifice cross-sectional area.

FIG. 6D is a schematic cross-sectional view of the mud operated pulser of FIG. 6A when the pilot valve is fully open, and the poppet is in the orifice to generate a pulse.

FIG. 6E is an enlarged cross-sectional view of a poppet and orifice as a main valve of the pulser of FIG. 6D, when the pilot valve is fully open, and the poppet is situated in full position within the orifice cross-sectional area.

FIG. 7 is a schematic cross-sectional view of an embodiment of the present invention illustrating a fluid-operated pulser with an exemplary pilot valve in a closed position and the main poppet valve in an unrestricted position.

FIG. 8 is a schematic cross-sectional view of the embodiment of FIG. 7 illustrating the exemplary pilot valve in an open position and the main poppet valve in a restricted position.

FIG. 9 is a schematic cross-sectional view of another embodiment of the present invention illustrating an exemplary pilot valve in a closed position with shock damping.

FIG. 10 is a schematic cross-sectional view of another embodiment of the present invention illustrating an exemplary pilot valve in a closed position.

FIG. 11 is a schematic cross-sectional view of another embodiment of the present invention illustrating an exemplary pilot valve in a closed position.

FIG. 12 is a schematic cross-sectional view of an embodiment of the present invention illustrating an exemplary pulser in an inverted position with a pilot valve closed and a main valve closed.

FIG. 13 is a schematic cross-sectional view of the embodiment of FIG. 12 illustrating the pulser in an inverted position with the pilot valve open and the main valve open.

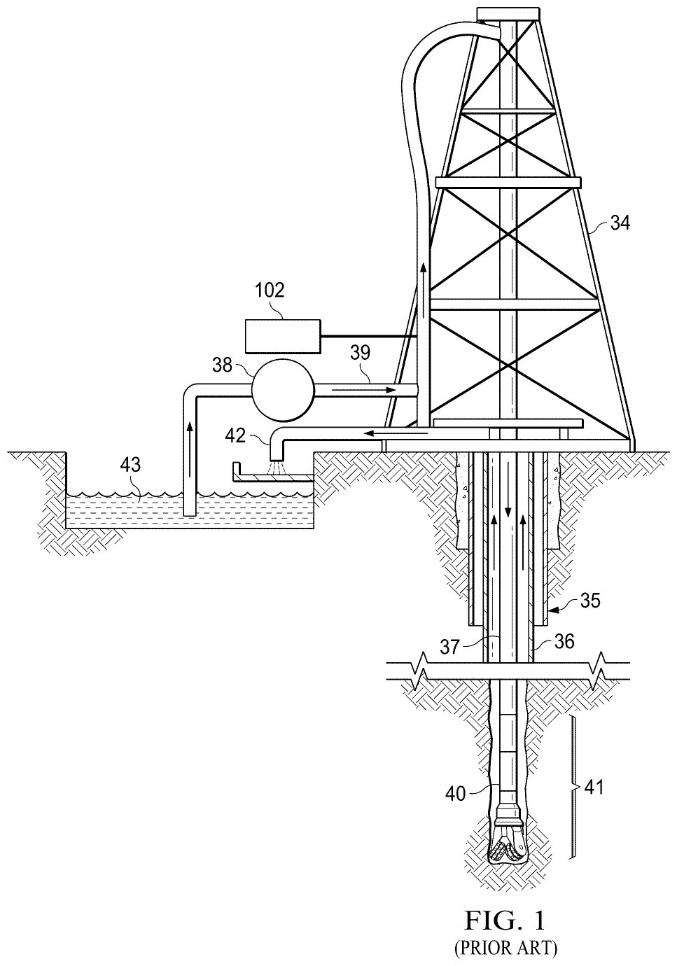

### DETAILED DESCRIPTION

The Figures described above, and the written description of specific aspects and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a”, is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of any embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. The subsurface terms “downhole” and “uphole” are relative to proximity to a ground surface, where uphole is closer, regarding of the actual gravitational orientation of up or down.

The disclosure provides an improved fluid operated pulser. The pulser utilizes a pilot valve to create differential pressure to directly actuate a main valve to block or unblock a fluid flow. The invention provides a main valve that is simpler, more reliable, and wear resistant. The invention uses a differential pressure inside the volume under a pilot valve to directly actuate a main valve to block or unblock the fluid flow through the orifice, and thus creates a positive pressure pulse inside the collar. The main valve has only one moving part, the main valve element. Some embodiments also have at least one spring. The main valve element can be spherical or cylindrical and rotate in a volume adjacent the pilot valve. The variable exposure of surface area results in reduced erosion on the main valve element to extend the main valve life, and reduces the need for stopping expensive operations just to replace the pulser.

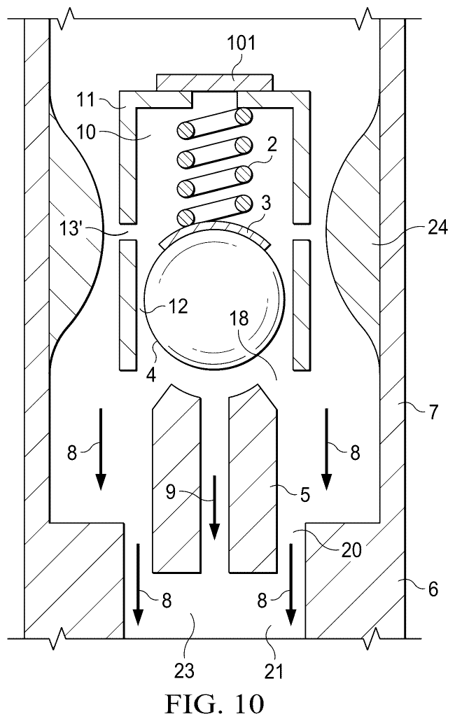

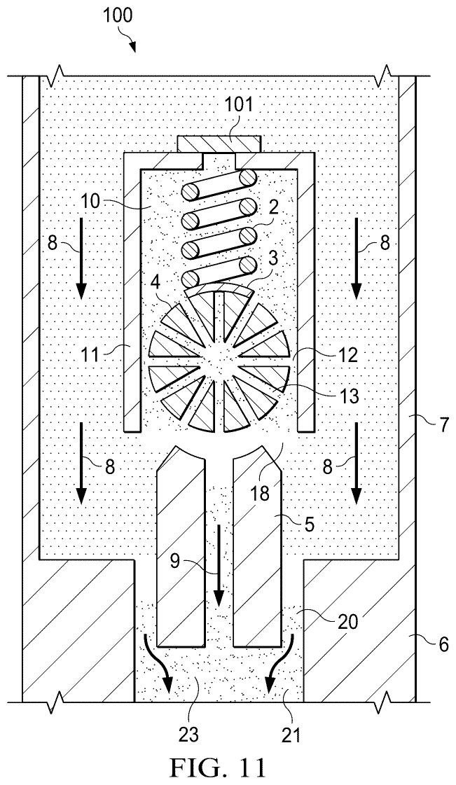

FIG. 7 is a schematic cross-sectional view of an embodiment of the invention illustrating a fluid-operated pulser with an exemplary pilot valve in a closed position and the main valve in an unrestricted position. Fluid flow in this figure is flowing from top to bottom. The fluid-operated pulser 100 is applicable to various fluids and without limitation drilling mud used in oilfield drilling operations. The disclosure uses the mud as an exemplary fluid in this disclosure with the express understanding that other fluids besides drilling mud and other applications beside drilling can find beneficial use of the pulser described herein. The pulser 100 includes a pilot valve 101 fluidicly coupled with a main valve 104. The pilot valve and main valve can share support structure such as the support structure the pilot valve can also support a structure for a main spring 2 for the main valve. The pilot valve 101 can be operated to slide across an opening and block and unblock fluid flow through the opening. A pulser controller 17 (illustrated in FIG. 10) can control the operation of the pilot valve and therefore creation of a pulse when the fluid is flowing through the various flow paths described herein.

The main valve 104 can include a main valve element 4 at least partially enclosed longitudinally in a main valve tube 11, a main valve orifice 5, various flow openings and passages as described herein, and in some embodiments a bias element such as a main spring 2. The main valve element is configured to block and unblock fluid flow through an orifice opening 9 in the main valve orifice 5, and thus create a pressure pulse inside a collar 7 around the pulser, which can be sensed along a drill string connected to the collar. The embodiment functions with simplicity from fewer moving parts and can have no seals, such as hydraulic pistons and other flow devices.

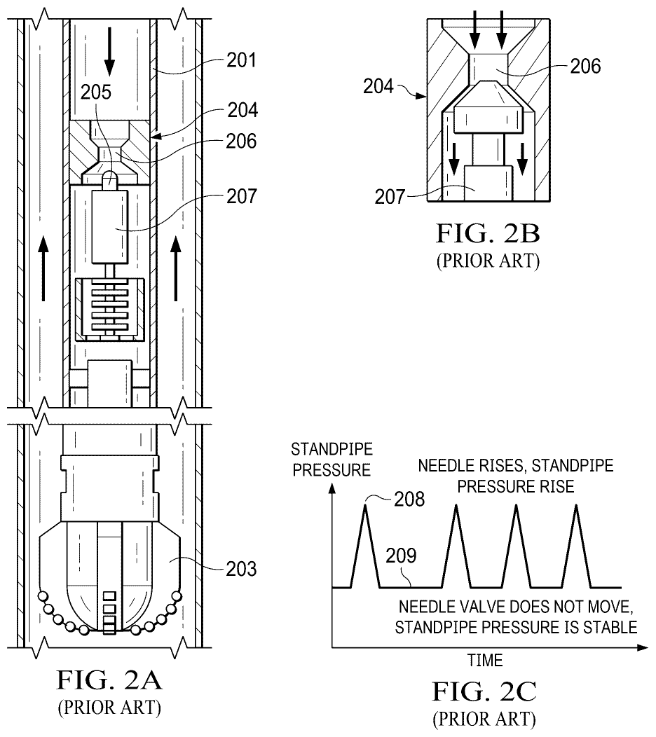

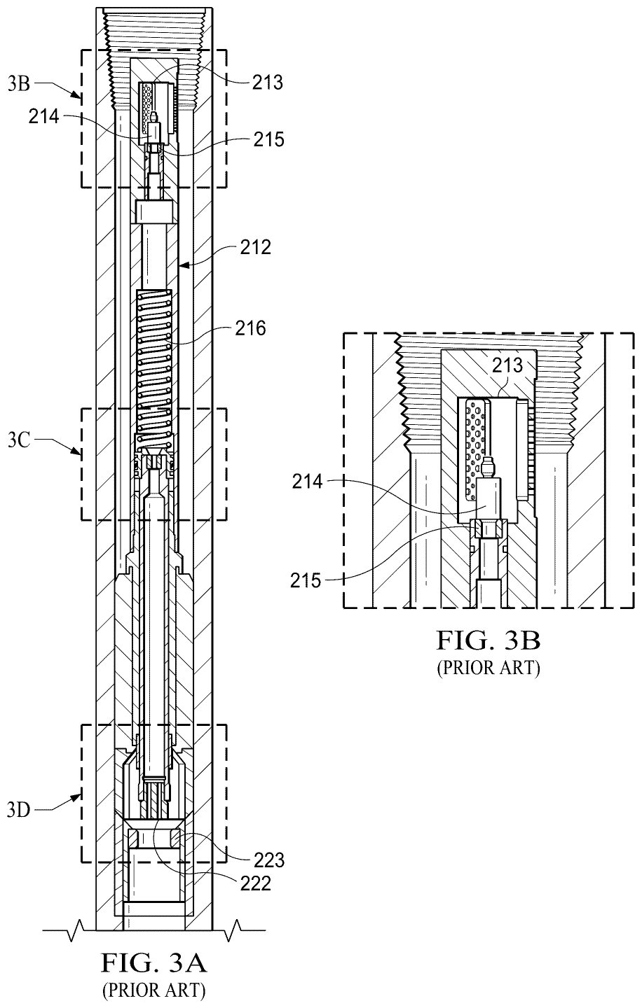

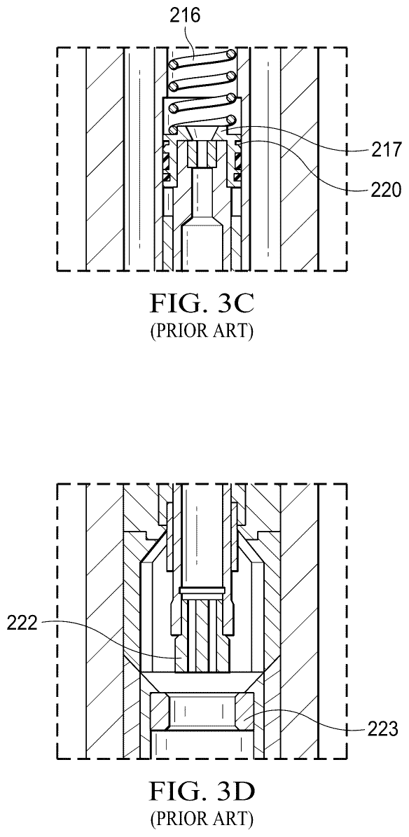

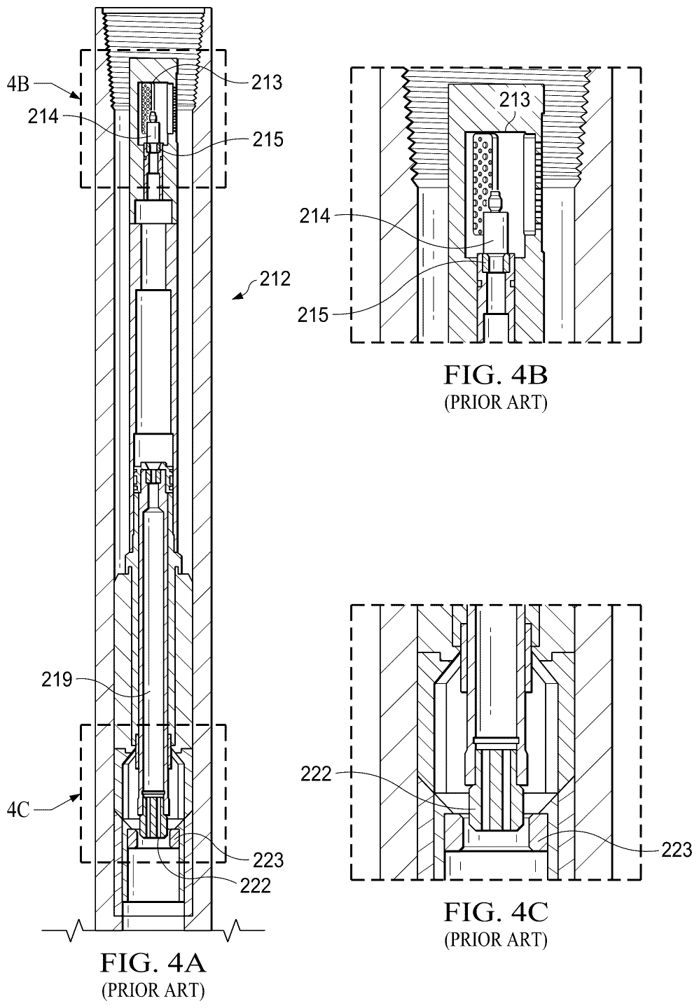

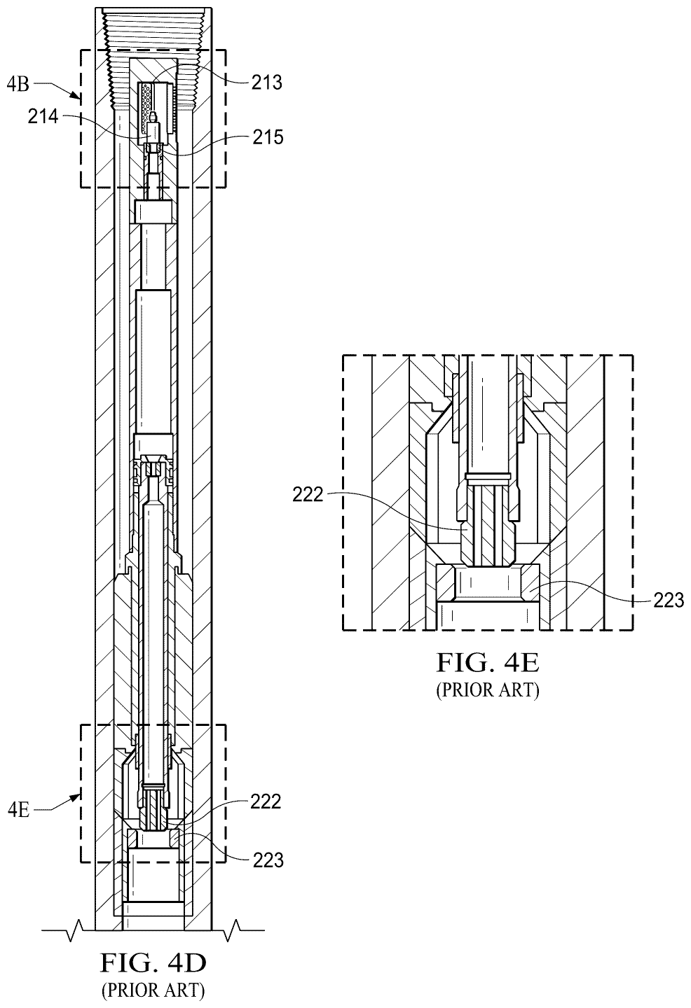

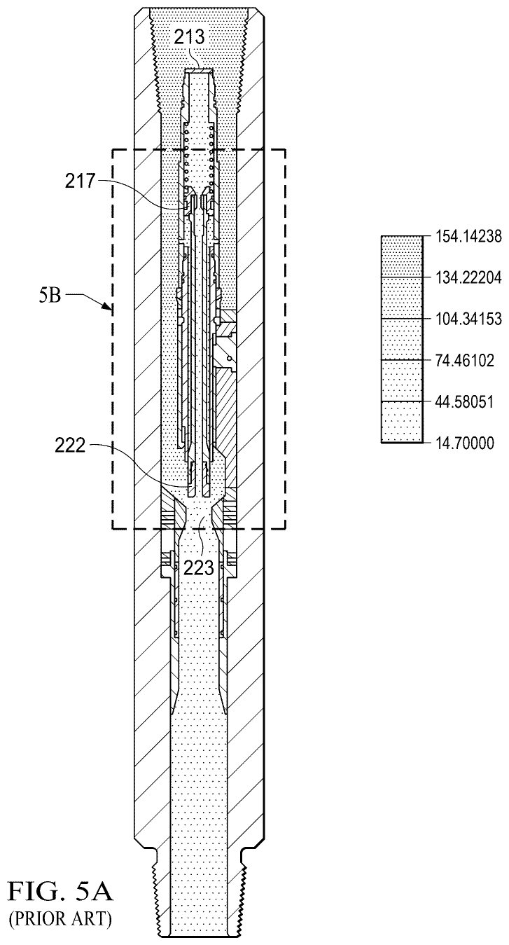

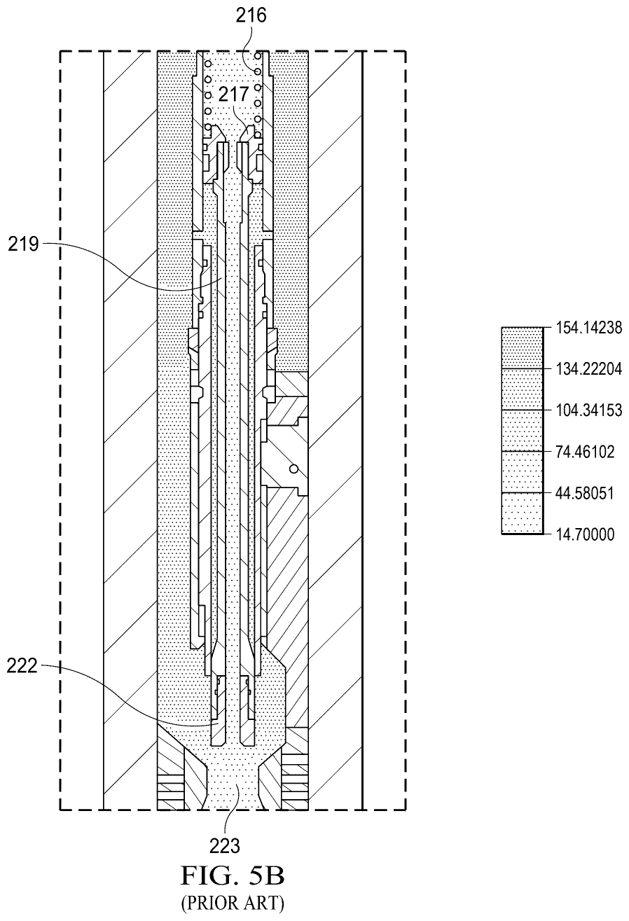

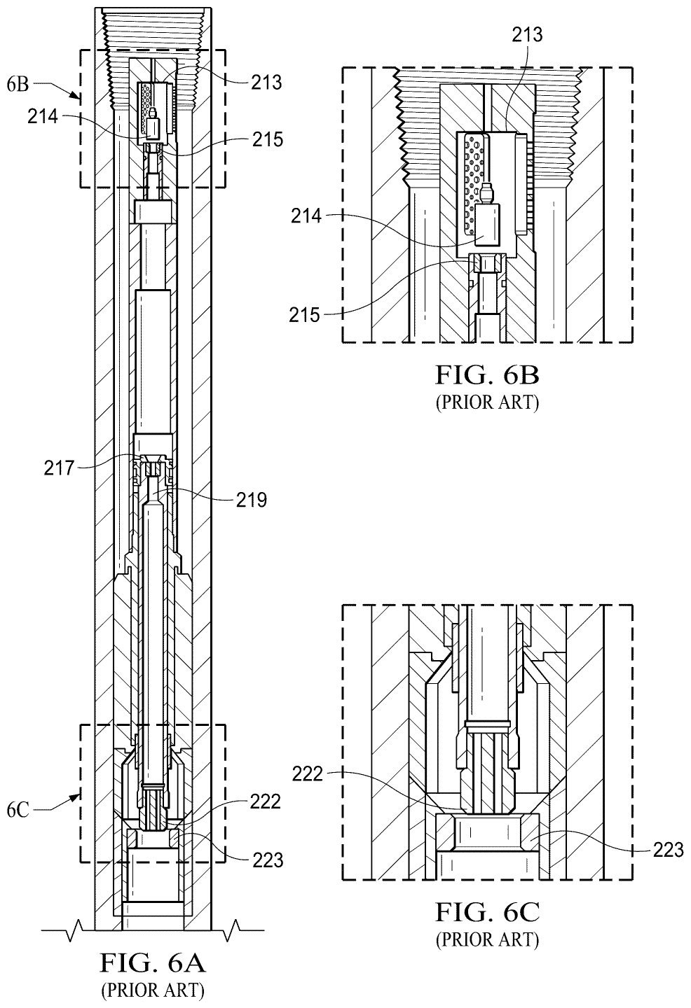

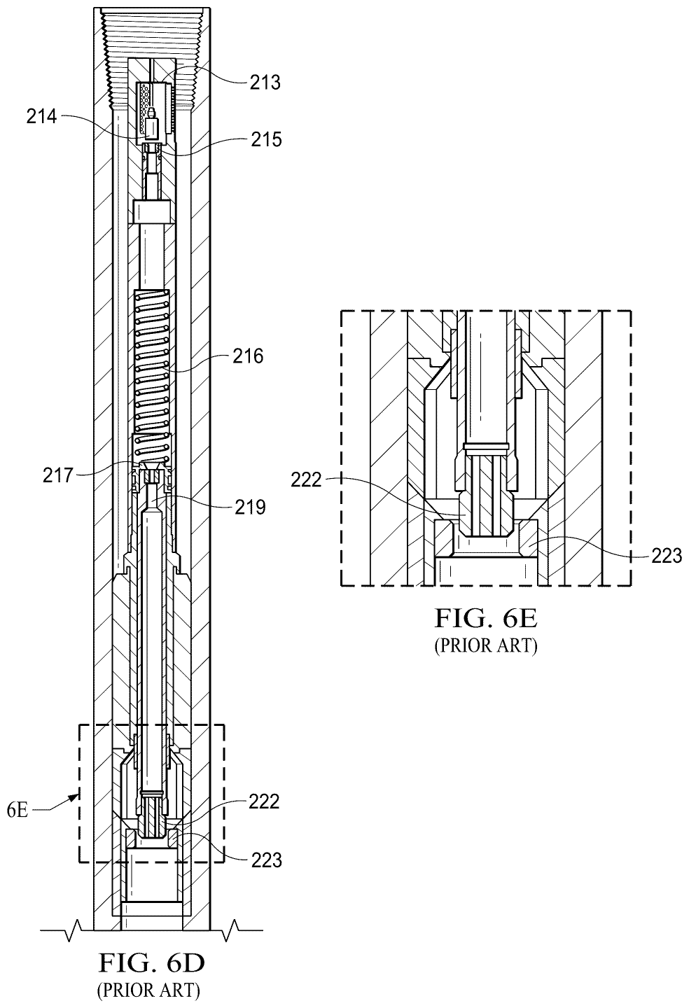

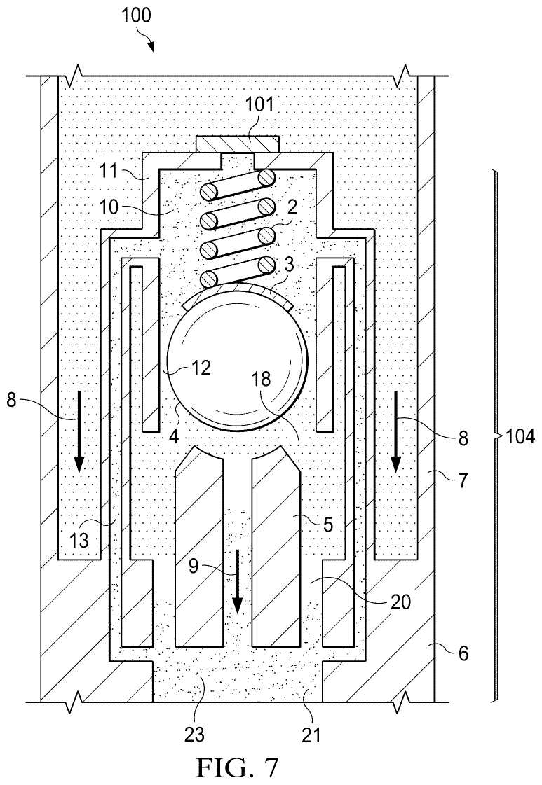

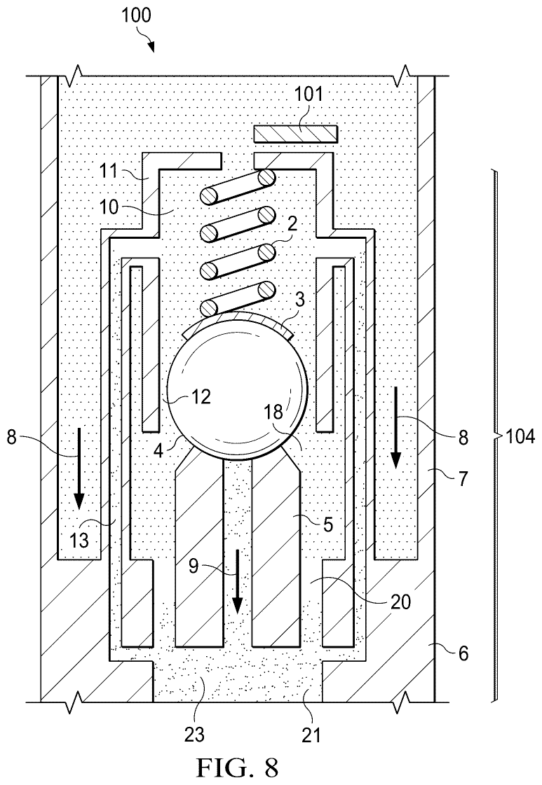

When the main valve 104 is closed, fluid is restricted from flowing through the main valve and thus the flow cross sectional area is reduced. The pressure increases due to the restriction to a higher pressure than steady state pressure that then reduces back to a lower pressure and eventually steady state pressure when the pilot valve reopens, thus forming a pulse such as shown in FIG. 2C. When the pilot valve is closed, fluid trapped in a volume 10 adjacent the pilot valve will start discharging to a lower pressure zone 23 downstream of the main valve orifice 5 via a flow bleed path channel 13 compared to the high-pressure zone upstream of the pilot valve and in the flow 8 inside the collar 7 around the pulser. The volume 10 between the pilot valve and the main valve element will develop a low-pressure zone compared to the high-pressure zone at times generated upstream by the pulser. Open areas into the pilot valve fluidicly couple a collar volume with a volume 18, generally below the main valve element 4, thus allowing the high-pressure fluid of the collar flow into such volume. The difference in pressures between the volume 10 and the volume 18 push the main valve element 4 in the volume 10 toward the pilot valve and away from the main valve orifice 5, thus allowing the fluid to exhaust through an orifice opening 9 in the main valve orifice. The main spring 2 is pre-loaded in compression to engage a spring cup 3 against the main valve element 4 when not energized by the pressures. A flow bleed path channel 13 assists in establishing a low-pressure within volume 10 during the pulser operation by allowing pressurized fluid to bleed off into a flow restrictor opening 21 or more generally a lower pressure zone 23 downstream of the pulser. A very small gap 12 between the main valve element 4 and the main valve tube 11 provides a fluid flow for lubrication of the main valve element during movement in the main valve tube.

In at least one embodiment, the main valve element 4 has a spherical shape. The spherical main valve element 4 is free to tumble in the restricted volume 10 and hence the sealing surface of the sphere will provide a more even wear over a longer time period compared to the piston and seals in typical known designs. In another embodiment, the main valve element 4 can be shaped as a cylinder with its longitudinal axis positioned transverse to the longitudinal axis of the main valve. Thus, the cylindrical main valve element could rotationally tumble around its longitudinal axis during movement up and down in the main valve tube. The movement would similarly distribute wear on the element surface in sealing against the main valve orifice 5. The outside diameter of the main valve element 4 can be sufficiently larger than the main valve orifice 5 outside diameter such that the differential pressure can move the ball into the volume 10. The terms “spherical” and “cylindrical” are used broadly and include variations, including but not limited to oblong elliptical shapes and combinations of spherical and cylindrical shapes.

Further, the spherical or cylindrical main valve element 4 can be made up of lighter material and/or hollow and coated with erosion resistant material, such as tungsten carbide, cobalt-chromium alloys, or rubber. The lower weight of the main valve element 4 will allow it to move up and down more quickly with lower differential pressure and create a sharper pressure pulse. An erosion-resistant coating on the main valve can extend further the life of the valve.

One concern is that the main valve element 4 being spherical with a smooth surface may form a vacuum seal with the matched shape surface of the main valve orifice 5. This vacuum seal may add an inertial force to move the main valve element away from the orifice when the pilot valve is operated in a different position. This will require higher differential pressure to move the main valve element 4. To avoid this vacuum seal, the spherical main valve element can have small surface contours deeper or higher than an average surface texture. An example is surface dimples like those formed on a golf ball, or surface channels formed in the surface of the main valve. Alternatively, the sealing surface of the main valve orifice 5 can be made with some channels or waves that may allow very little flow to pass through but still create a differential flow-pressure in the collar 7 compared to the flow-pressure in volume 10. Due to this very small flow leak, this surface may advantageously be coated with material resistive to erosion.

Because fluid flows though the main valve orifice 5, the pressure of flow 8 inside collar 7 is normally a lower pressure as shown in the chart of FIG. 2. Additional flow bypass is achieved by a flow restrictor 6 through a flow bypass opening 20 to a flow restrictor opening 21. In an oil well, the fluid flow can range from about a high flow of about 1500 GPM (gallons per minute) to about a low flow of 200 GPM. Based on the overall flow rate and the amount of pressure pulse amplitude desired, the flow bypass opening 20 and the opening 9 of the orifice 5 can be designed to accommodate the wide fluctuation of flow.

FIG. 8 is a schematic cross-sectional view of the embodiment of FIG. 7 illustrating the exemplary pilot valve in an open position and the main valve in a restricted position that blocks flow through the orifice. When the pilot valve 101 is open, the fluid flows through the pilot valve from the collar into the volume 10 and hence the pressure equalizes between volume 10 under the pilot valve, flow inside the collar 8, and the volume 18 under the main valve element 4. With the equalization of pressures, the main valve element 4 can be pushed by the main spring 2 against the main valve orifice 5 to block the orifice opening 9 inside the main valve orifice. Since the fluid flow is restricted to flow through the bypass restriction only, a positive pressure pulse is created. The flow is stopped through the main valve orifice 5, which is closed by the main valve element 4. Thus, by closing, opening, and closing the pilot valve in at least this embodiment, a positive fluid pressure pulse can be created.

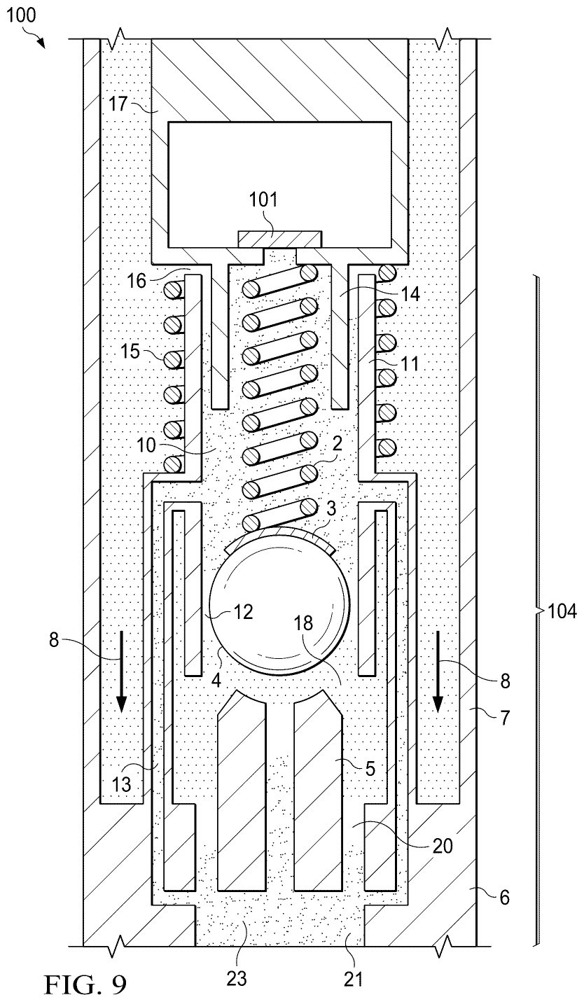

FIG. 9 is a schematic cross-sectional view of another embodiment of the present invention illustrating an exemplary pilot valve in a closed position with shock damping. A housing including the pilot valve 101 can include a pulser controller 17 and associated electronics, such as MLWD sensor probes, including D&I [Directional & Inclination] probes and Gamma probes. The drilling tool string including the housing undergoes large scale axial shock and torsional movement during drilling operations that can cause premature failure of such electronics and probes. This exemplary embodiment can dampen such forces with a damping spring 15 and potentially extend the life of the electronics and probes.

The pulser controller 17 with a pilot valve tube 14 can be slidably engaged with a main valve tube 11. The pilot valve tube can be supported by a shock damping string 15 between opposing surfaces of the pilot valve tube and the main valve tube. Advantageously, there can be an annular gap 16 between the pilot valve tube 14 and main valve tube 11. Because the pilot valve tube 14 may move freely, in axial and torsional directions relative to the main valve tube 11, the axial shock or torsion movement applied to the pilot valve tube can be damped by damping spring 15 damping the axial shock or torsion movement to the pilot valve tube 14 and the pulser electronics 17. The damping reduces the axial and torsional shock and vibrations to the pilot valve 101 and pulser controller 17.

When the pilot valve 101 is closed, the design of this assembly can be optimized to achieve a few hundred pounds per square inch of differential pressure between the volume 10 adjacent the pilot valve and the pressure inside the collar. This differential can be achieved by designs of the bypass flow restrictor 6 with the flow bypass opening 20 and the opening 9 of the orifice 5.

FIG. 10 is a schematic cross-sectional view of another embodiment of the present invention illustrating an exemplary pilot valve in a closed position. In this embodiment, the main configuration includes a surrounding venturi structure 24 around the pulser 100, which has geometries to create a low-pressure zone due to a Venturi effect. When the pilot valve 101 is closed, fluid flow will accelerate due to the reduced internal diameter of the venturi structure 24, where the fluid flows past the main valve tube 11. In this area, there is a flow bleed path channel 13, which provides an opening through the wall of the main valve tube 11 longitudinally between the main valve element 4 and the pilot valve 101, generally close to the main valve element. The Venturi effect in this area will lower the pressure in this zone outside the main valve tube 11. High-pressure fluid trapped inside the volume 10 under the pilot valve will bleed out through the flow bleed path channel 13, making the pressure above the main valve element 4 a lower pressure than the pressure below the main valve element 4 that is open to the flow 8 through the venturi structure 24. Therefore, the main valve element 4 will be pushed off the main valve orifice 5 into the volume 10, reopening the fluid flow to pass through the orifice opening 9 in conjunction with flow bypass opening 20. This action will reduce the pressure in the collar 7 back to the steady state value to end the pulse.

Conversely, when the pilot valve 101 is open, the fluid flowing in the collar 7 is allowed to enter in the volume 10 through the pilot valve 101, creating pressure on the main valve 4 to move away from the pilot valve 101. The pressure generated by the fluid flowing in volume 10, along with pressure from a spring, if used, pushes the main valve 4 onto the main valve orifice 5 and closes the fluid flow through the orifice opening 9. As a result, fluid is only flowing through the restricted area of bypass channels 20 into the lower pressure zone 23 and not through the orifice opening 9, resulting in higher pressure in the collar.

Again, by closing the pilot valve 101, the main valve element opens and pressure inside the collar returns to lower steady state. This action of controlling the pilot valve 101 by closing-opening-closing generates a pressure spike in the collar 7, which travels upstream where it can be detected. In sum, the flow bleed path channel channels 13 formed through the main valve tube 11, being close to a high speed (low pressure) area of the collar, provide a design for the main valve element movement and functioning of the pulser.

FIG. 11 is a schematic cross-sectional view of another embodiment of the present invention illustrating an exemplary pilot valve in a closed position. In this embodiment, the main valve element 4 has several radially drilled, small bleed holes for the fluid volume to escape to the lower pressure zone 23 when the pilot valve 101 is closed. The differential pressure between a lower-pressure volume 10 between the main valve element 4 and the pilot valve compared to the higher pressure below the main valve element including volume 18 can push the main valve element 4 off the orifice 5 into the volume 10 to open the flow through the orifice opening 9 and reduce pressure in the collar back to the steady state value. Because at least one embodiment of the main valve element 4 is spherical and allowed to tumble in the restricted area inside main valve tube 11, several radial or diametric holes can be formed for the fluid bypass channels. As a result, at least one fluid bypass channel is designed to be open at any given time for fluid in volume 10 under the pilot valve to bleed to the lower pressure zone 23 regardless of rotational orientation of the main valve element. Further, the design and spacing between these channels can be such that at least one channel will allow the fluid flow from the volume 10 under the pilot valve into the orifice opening 9 of the main valve orifice 5 and to the lower pressure zone 23. Additionally, a floating ring (not shown) around a downhole portion of the main valve element can assist in pressure control above and below the main valve element to help avoid unwanted leakage through a channel as the main valve element tumbles. When the pilot valve is open, the fluid flowing in the collar is allowed to enter in the volume 10 under the pilot valve 101, creating downward pressure on the main valve element 4. Along with the force of the main spring 2 downward and the downward pressure generated by the fluid flowing in volume 10, the main valve element 4 is pushed toward the orifice 5 and away from the pilot valve 101, closing the fluid flow through the orifice opening 9. As a result, fluid flowing downward is only going through the restricted area of flow bypass openings 20, resulting in an elevated pressure in the collar. Again, by closing the pilot valve 101, the main valve opens and pressure inside the collar returns to lower steady state. This action of controlling the pilot valve close-open-close generates a pressure spike in the collar which travels upstream where it can be detected.

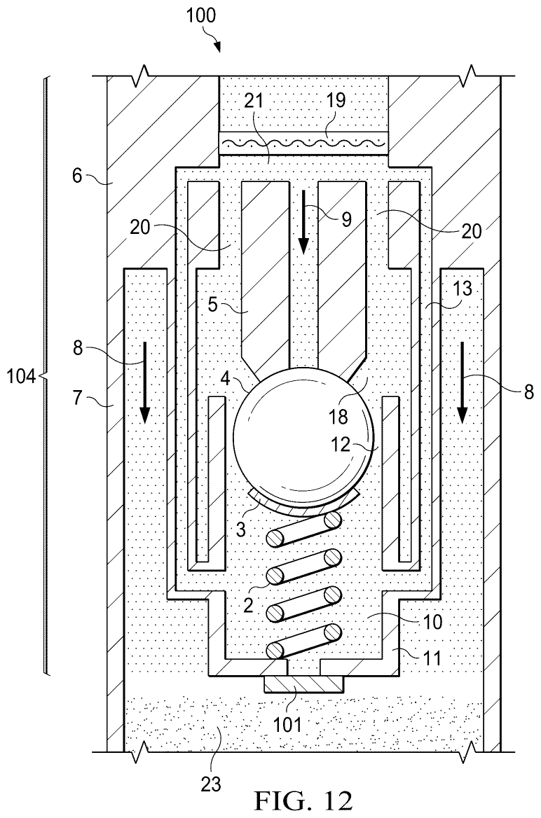

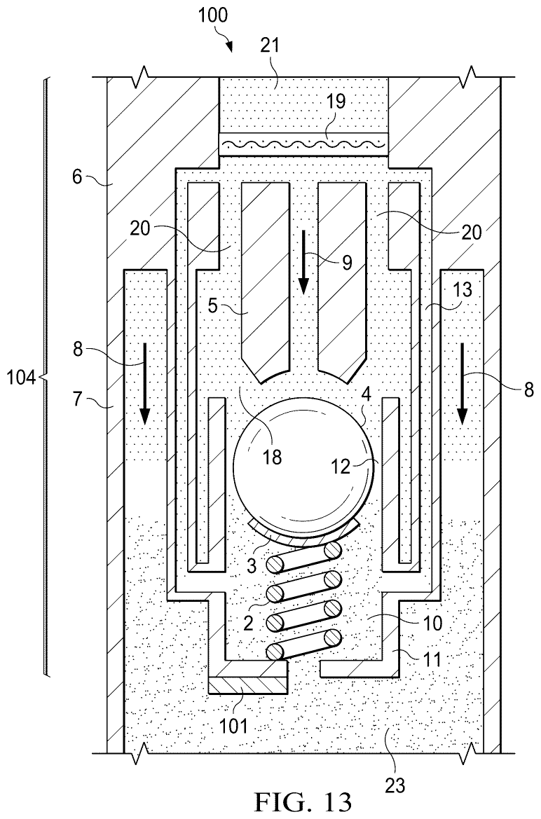

FIG. 12 is a schematic cross-sectional view of an embodiment of the present invention illustrating an exemplary pulser in an inverted position with a pilot valve closed and a main valve closed. FIG. 13 is a schematic cross-sectional view of the embodiment of FIG. 12 illustrating the pulser in an inverted position with the pilot valve open and the main valve open. Most MWD tools have three sections: the power supply, electronics housing, and pulser assembly. One of the standard configurations to assemble the MWD tool is with a power supply in the top (that is, uphole relative to the other two sections), electronics housing in the middle, and pulser assembly in the bottom (that is, downhole of the electronics housing). FIGS. 7-11 illustrate this standard configuration of the pulser section being in the bottom. This position allows the MWD tool to supply power to uphole LWD tools easily without running wires through a complicated constantly moving mechanical assembly.

At other times, the MWD tool needs to supply power downhole to other types of tools, including downhole LWD tools. One solution is to assemble the power supply on the bottom of the electronics housing and the pulser assembly on the top of the electronics housing. Because there are no electrical connections on the bottom side of the pulser assembly, the pulser assembly can be inverted upside down from the bottom mounted configuration shown in FIGS. 7-11. The inverted pulser assembly becomes a top mounted pulser assembly and can be connected to the top of the electronics housing and the electronics housing can be connected to the top of the power supply. For example, a top mounted pulser assembly can provide pressurized fluid downhole to power a turbine-generator, mounted below the electronics housing, to generate power.

The top mounted pulser shown in FIGS. 12 and 13 contains a main valve element 4 to block fluid flowing through a main valve orifice 5, and thus create a pressure pulse inside the collar 7. The embodiment can function with simplicity from fewer moving parts and can have no seals, such as in hydraulic pistons and other flow devices.

In such a top mounted pulser, the fluid is flowing in this figure from top to bottom in the direction from the main valve orifice 5 to the pilot valve 101. The invention explained previously works in the same principle for a top mounted pulser as described above for FIGS. 7 and 8, as adjusted for flow through an inverted orientation of components. When the pilot valve 101 is closed, the downward flow in the flow bleed path channels 13 will pressurize the fluid in volume 10 between the pilot valve 101 and main valve element 4 until the fluid pressure in the volume 10 equalizes the upstream pressure above the main valve. This pressure in volume 10 exerts upward pressure on the spring cup 3. In addition, the upward force applied by the compressed main spring 2 on the spring cup 3 on the main valve element 4, the difference in pressures between the volume 10 and the volume 8 pushes the main valve element 4 towards the main valve orifice 5, sealing the orifice opening 9 through the main valve orifice. Restricting the flow path through the orifice opening 9 for the fluid creates a high-pressure inside the collar 7, which initiates the pressure pulse. The flow bleed path channel 13 assists in maintaining high-pressure within volume 10. A very small gap 12 between the main valve element 4 and a main valve tube 11 provides a small leakage of fluid flow for lubrication of the main valve for movement in the main valve tube 11. In at least one embodiment, a spherical main valve element 4 can tumble in the volume 10 and hence the sealing surface of the sphere will experience a more uniform wear over a time period compared to the linear piston and surrounding seals in the conventional designs allowing longer time between maintenance. As described above, a cylindrical main valve element can also be allowed to rotate along its longitudinal axis that is transverse to a longitudinal axis through the pulser 100.

A debris screen 19 can be provided to reduce fluid clogging of the flow bleed path channel 13. The debris screen 19 can cover the flow path across the flow restrictor opening 21 that allows the fluid to enter the pulser. However, the debris screen 19 only needs to cover the flow bleed path channel 13, and not necessarily the entire flow path.

When pilot valve 101 is open, as shown in FIG. 13, the fluid in volume 10 flows out to the lower pressure zone 23 downstream of the pulser, creating a lower pressure in the volume 10 under the main valve element 4. A downward pressure on the main valve element 4 from the high-pressure zone upstream, now pushes the main valve element 4 in the lower pressure zone into volume 10 away from the main valve orifice 5 and toward the pilot valve 101, thus unsealing the main valve orifice 5. The flow of fluid through the orifice opening 9 of the main valve orifice 5 reduces pressure inside the collar 7. This reduction results in finishing the high-pressure pulse created initially when the pilot valve 101 was closed as the pressure returns to steady state in the pulser.

Other and further embodiments utilizing one or more aspects of the inventions described above can be devised without departing from the disclosed invention as defined in the claims. For example, different shapes of the pilot valve, collar, different numbers of flow bleed path channels and locations, different applications other than MLWD, and other variations than those specifically disclosed herein within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. A fluid-operated pulser comprising:
a pilot valve configured to selectively allow fluid to flow through the pilot valve;
a hydraulic main valve fluidicly coupled to the pilot valve, comprising:
a main valve tube having a main valve tube volume and fluidicly coupled to the hydraulic pilot valve;
a main valve orifice having an opening to allow the fluid to flow through the main valve orifice;
a main valve element longitudinally movable in the main valve tube between the pilot valve and the main valve orifice and selectively engageable with the opening of the main valve orifice to selectively allow the fluid to flow through the main valve orifice; and
a flow bleed path channel fluidicly coupled between the main valve tube volume and a low pressure zone.

2. The pulser of claim 1, further comprising a flow restrictor fluidicly coupled to the main valve orifice having an opening fluidicly coupled to the main valve orifice opening to allow the fluid to flow through the flow restrictor opening and having a flow bypass opening separate from the main valve orifice opening and fluidicly coupled to the flow restrictor opening.

3. The pulser of claim 1, wherein the main valve element is formed as a spherical shape and the pulser is configured to allow the main valve element to tumble in a volume between the pilot valve and the main valve orifice.

4. The pulser of claim 3, wherein the main valve element is formed with surface contours.

5. The pulser of claim 1, wherein the main valve element is formed as a cylindrical shape having a longitudinal axis and the pulser is configured to allow the main valve element to rotate around a transverse axis of the main valve element in a volume between the pilot valve and the main valve orifice.

6. The pulser of claim 5, wherein the main valve element is formed with surface contours.

7. The pulser of claim 1, further comprising a main spring configured to bias the main valve element toward the opening of the main valve orifice.

8. The pulser of claim 1, further comprising a pilot valve tube coupled to the pilot valve and slidably engaged with the main valve tube, the pilot valve tube biased by a spring longitudinally away from the main valve tube.

9. The pulser of claim 8, wherein the pilot valve tube is configured to engage the main valve tube and dampen shock and vibration in the pulser.

10. The pulser of claim 1, further comprising a pulser controller coupled to the pilot valve configured to actuate the pilot valve for pulse control with the fluid flow.

11. The pulser of claim 1, wherein the main valve element comprises a plurality of cross-sectional openings configured to form at least one flow bleed path channel independent of a rotational orientation of the main valve element on the orifice.

12. The pulser of claim 1, further comprising a collar forming a collar volume surrounding the pilot valve and main valve, the collar configured to be coupled to a drill string and allow the fluid to flow through the collar volume and through the pilot valve and main valve.

13. The pulser of claim 1, wherein the main valve element is downstream of the pilot valve.

14. The pulser of claim 13, wherein during operation with flowing fluid, a closed pilot valve creates low-pressure fluid between the pilot valve and the main valve element with high-pressure fluid on the main valve element distal from the pilot valve that pushes the main valve element toward the pilot valve and away from the orifice that allows fluid to flow through the orifice opening and the flow bypass opening.

15. The pulser of claim 14, wherein a main spring creates a force that pushes the main valve element toward the main valve orifice.

16. The pulser of claim 13, wherein during operation and the pilot valve is open, high-pressure pushes the main valve element away from the pilot valve and toward the main valve orifice and fluid flow is restricted through the main valve orifice opening while the fluid flows through the flow bypass opening.

17. The pulser of claim 13, wherein the flow bleed path channel is downstream of the pilot valve and fluidicly couples a volume between the pilot valve and the main valve element to a low pressure zone downstream of the main valve element to establish a differential pressure and to allow flow into the low pressure zone to bleed out.

18. The pulser of claim 13, further comprising a debris screen disposed across a flow path upstream of the flow bleed path channel.

19. The pulser of claim 1, wherein the main valve element is upstream of the pilot valve.

20. The pulser of claim 19, wherein during operation with flowing fluid, a closed pilot valve creates high-pressure fluid between the pilot valve and the main valve element that equalizes fluid pressure on the main valve element distal from the pilot valve that pressures the main valve element toward the main valve orifice and away from the pilot valve that restricts fluid flow through the orifice opening.

21. The pulser of claim 20, wherein a spring creates a force that pushes the main valve element toward the main valve orifice.

22. The pulser of claim 19, wherein during operation and the pilot valve is open, high-pressure pushes the main valve element away from the main valve orifice opening and toward the pilot valve and fluid flow is released to flow through the main valve orifice opening.

23. The pulser of claim 19, further comprising a debris screen disposed across a flow path upstream of the flow bleed path channel.

24. The fluid operated pulser of claim 1, further comprising a gap between main valve element and main valve tube that provides fluid lubrication of the main valve.

25. The fluid operated pulser of claim 1, wherein the main valve element comprises comprising erosion resistant material.

26. The fluid operated pulser of claim 1, further comprising a venturi structure surrounding the pulser.

27. The fluid operated pulser of claim 26, wherein the venturi creates a low pressure adjacent the flow bleed path channel and wherein the flow bleed path channel is formed through a wall of the main valve tube.

28. The fluid operated pulser of claim 1, where the flow bleed path channel is formed through the main valve element.
